(19) United States
(12) Patent Application Publication
(10) Pub. No.: US 2026/0133068 A1
(43) Pub. Date: May 14, 2026

(54) SYSTEM AND A METHOD FOR DARK CURRENT ELIMINATION

(71) Applicant: TriEye Ltd., Tel Aviv (IL)

(72) Inventors: Amir Ziv, Tel Aviv (IL); Eran Katzir, Tel Aviv (IL); Nadav Melamud, Tel Aviv (IL); Yosef Melamed, Tel Aviv (IL); Omer Kapach, Tel Aviv (IL); Avraham Bakal, Tel Aviv (IL); Uriel Levy, Tel Aviv (IL)

(21) Appl. No.: 19/117,965

(22) PCT Filed: Nov. 8, 2022
(86) PCT No.: PCT/IB2022/060749

§ 371 Date: Apr. 3, 2025

(51) Int. Cl. G01J 1/44

(52) U.S. Cl. CPC G01J 1/44; G01J 2001/444; G01J 2001/446

(57) ABSTRACT

Consistent with disclosed embodiments, a system includes: a photodetector (PD), wherein the PD generates a first type of electrical charge and a second type of electrical charge; an integrating capacitor connected to the PD; a controller configured to switch between a first collection state of the integrating capacitor and a second collection state of the integrating capacitor, wherein, during the first collection state, the integrating capacitor is charged by the first type of electrical charge derived from photocurrent and by first type of electrical charge derived from dark current, and wherein, during the second collection state, the integrating capacitor is discharged by the second type of electrical charge derived from dark current, wherein the first type of electrical charge is inversed to the second type of electrical charge such that electrical charges derived from dark current are thereby substantially eliminated.

### CROSS REFERENCE TO RELATED APPLICATIONS

This is a 371 application from international patent application PCT/IB2022/060749 filed Nov. 8, 2022

[symbol]

### FIELD

The disclosure relates to photonic systems and more specifically to systems and methods for eliminating or substantially reducing dark current effects in such systems.

### BACKGROUND

Photodetecting devices such as photodetector arrays may include a multitude of photosites, each including one or more photodetectors for detecting impinging light, and a capacitor for storing charge provided by the photodetector. The capacitor may be implemented as a dedicated capacitor and/or using parasitic capacitance of the photodiode, transistors, and/or other components of the photosite.

In use, a photodiode (photodetector) having p and n doped regions may be reverse biased by connection of an applied voltage (positive voltage to the cathode (n region) and negative voltage to the anode (p region)) thereby increasing the depletion region at the pn junction. Photons from impinging light that illuminate the photodiode and that are absorbed in the depletion region (or close to it) will create electron hole pairs that will move to opposite ends of the photodiode due to the electric field from the applied voltage. Electrons will move toward the positive potential on the cathode, and holes will move toward the negative potential on the anode. These moving charge carriers (electrons and holes) form the photocurrent in the photodiode that is proportional to the illumination. The charge associated with this photocurrent may be collected in a capacitor during an “integration time” or “integration period” namely the time period during which current flowing into a capacitor causes charge to accumulate after which the level of stored charge may be determined. The length of an integration time may be chosen based on factors such as but not limited to the sensitivity of the photodetector and/or the brightness of the impinging light.

Dark current is a well-known phenomenon in the world of charge-coupled devices (CCDs) and light-sensitive integrated circuit. Dark current arises from thermal energy within the material lattice that includes the CCD. Electrical charge, e.g., electrons are created over time and are independent of the light falling on the detector. When referring to photodetectors or photodiodes, dark current describes an electric current that flows through the photodetector, including when no photons are entering the device such as when the photodetector is not illuminated. Dark current in photodetectors may result from random generation of electrons and holes within a depletion region of the photodetector. When the photodetector is connected to an integrating capacitor (for example in a camera) the dark current may be “counted” as a signal and may fill the capacitor with redundant charge, e.g., a null signal, which may prevent longer integration times required in some conditions, such as, for example, low light conditions. It should be understood by one skilled in the art that this increase in signal also carries a statistical fluctuation known as “dark current noise”.

Current approaches for reducing such dark current may include using a “dummy” photodetector which is shielded from illumination, and subtracting the signal detected by the “dummy” photodetector from the signal of another photodetector which is exposed to illumination. Drawbacks of such methods may include large area requirements and sophisticated electronic circuits at a higher level, for example, in a readout integrated circuit (ROIC).

In photodetectors characterized by dark current accumulation, there is therefore a need for, and it would be advantageous to physically eliminate dark current using a simple and cost-effective solution implemented at the photodetector level.

### SUMMARY

Consistent with disclosed embodiments, a system includes: a photodetector (PD), wherein the PD generates a first type of electrical charge and a second type of electrical charge; an integrating capacitor connected to the PD; a controller configured to switch between a first collection state of the integrating capacitor and a second collection state of the integrating capacitor, wherein, during the first collection state, the integrating capacitor is charged by the first type of electrical charge derived from photocurrent and by first type of electrical charge derived from dark current, and wherein, during the second collection state, the integrating capacitor is discharged by the second type of electrical charge derived from dark current, wherein the first type of electrical charge is inversed to the second type of electrical charge such that electrical charges derived from dark current are thereby substantially eliminated.

In some embodiments, the first collection state is synchronized with illumination reaching the PD and wherein the second collection state is synchronized with no illumination reaching the PD. In some embodiments, the first collection state is synchronized with generation of the first type of electrical charge and wherein the second collection state is synchronized with generation of the second type of electrical charge.

In some embodiments, the first type of electrical charge and the second type of electrical charge are respectively holes and electrons or vice versa. In some embodiments, the controller is configured to alternatively route, during the first collection state, the first type of electrical charge to the integrating capacitor and during the second collection state, the second type of electrical charge to the integrating capacitor. In some embodiments, the system further includes an optical shutter configured to allow or block illumination reaching the PD. In some embodiments, the optical shutter is controlled by the controller and is configured to allow or block illumination reaching the PD in synchronization with switching between the first collection state and the second collection state. In some embodiments, the optical shutter is one of a mechanical optical shutter, a liquid crystal optical shutter, a MEMS optical shutter, or an active grating resonance coupling.

In some embodiments, the system further includes a switching system connecting the PD and the integrating capacitor, wherein the switching system is configured to switch between the first collection state and the second collection state. In some embodiments, the switching system includes a first, a second and a third switches, the first switch between the PD and the integrating capacitor, the second switch between the PD and the third switch, and the third switch between a power supply, the PD, and the integrating capacitor.

Consistent with disclosed embodiments, a method includes: providing a photodetector (PD) connected to an integrating capacitor, and to a controller, wherein the PD generates a first type of electrical charge and a second type of electrical charge inversed to the second type of electrical charge; switching, by the controller, to a first collection state of the integrating capacitor; charging the integrating capacitor, during the first collection state, by a first type of electrical charge derived from photocurrent and by a first type of electrical charge derived from dark current; switching, by the controller, to a second collection state of the integrating capacitor; and discharging the integrating capacitor, during the second collection state, by the second type of electrical charge derived from dark current, thereby substantially eliminating electrical charges derived from dark current.

In some embodiments, the first collection state is synchronized with illumination reaching the PD and wherein the second collection state is synchronized with no illumination reaching the PD. In some embodiments, the first collection state is synchronized with generation of the first type of electrical charge and wherein the second collection state is synchronized with generation of the second type of electrical charge.

In some embodiments, the first type of electrical charge and the second type of electrical charge are respectively holes and electrons or vice versa. In some embodiments, the controller is configured in the first collection state and the second collection state to respectively route the first type of electrical charge and the second type of electrical charge to the integrating capacitor.

In some embodiments, the method further includes, providing an optical shutter configured to allow or block illumination of the PD. In some embodiments, the optical shutter is controlled by the controller and wherein the allowing or blocking of illumination is substantially synchronized by the controller with the switch between the first collection state and the second collection state. In some embodiments, the optical shutter is one of a mechanical optical shutter, a liquid crystal optical shutter, a MEMS optical shutter, or an active grating resonance coupling.

In some embodiments, the method further includes providing a switching system connecting the PD and the integrating capacitor, wherein the switching system is configured to switch between the first collection state and the second collection state. In some embodiments, the switching system includes first, second and third switches, the first switch between the PD and the integrating capacitor, the second switch between the PD and the third switch, and the third switch between a power supply, the PD, and the integrating capacitor.

Consistent with disclosed embodiments, a system includes: a photodetector (PD), wherein the PD generates a first type of electrical charge derived from combined photocurrent and dark current and a second type of electrical charge derived from dark current; an integrating capacitor connected to the PD; a switching system, and a controller configured to switch between a first collection state of the integrating capacitor and a second collection state of the integrating capacitor using the switching system, wherein, during the first collection state, the integrating capacitor is charged by the first type of electrical charge, and wherein, during the second collection state, the integrating capacitor is discharged by the second type of electrical charge, wherein the first type of electrical charge is inverted by the switching system relative to the second type of electrical charge such that the inversion leads substantially to cancelation or elimination of electrical charges derived from the dark current as a net number of electric charges derived from the dark current and collected by the integrating capacitor becomes substantially zero.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a schematic block diagram illustrating a system for dark current elimination, in accordance with some implementations of the presently disclosed subject matter;

FIGS. 2A and 2B are illustrative electrical circuit diagrams of a system for dark current elimination, in accordance with some implementations of the presently disclosed subject matter;

FIG. 3 is a flow chart of an example process for dark current elimination in an imaging system according to some implementation of the presently disclosed subject matter;

FIGS. 4A and 4B are exemplary graphs illustrating accumulated voltage across an integrating capacitor during a plurality of successive collection states, according to some implementations of the presently disclosed subject matter;

FIG. 5 is a flow chart of an example process for dark current elimination in an imaging system according to some implementation of the presently disclosed subject matter; and

FIG. 6 is an exemplary graph illustrating accumulated voltage across an integrating capacitor during a plurality of successive collection states, according to some implementations of the presently disclosed subject matter.

### DETAILED DESCRIPTION

In the following detailed description, numerous specific details are set forth to provide a thorough understanding of the disclosure. However, it will be understood by those skilled in the art that the present disclosure may be practiced without these specific details. In other instances, well-known methods, procedures, and components have not been described in detail so as not to obscure the present disclosure. In the drawings and descriptions set forth, identical reference numerals indicate those components that are common to different embodiments or configurations. It will be appreciated that for simplicity and clarity of illustration, elements shown in the figures have not necessarily been drawn to scale. For example, the dimensions of some of the elements may be exaggerated relative to other elements for clarity.

This disclosure describes systems and methods that may substantially reduce or eliminate dark current produced by photodetectors. Elimination of the dark current produced by a photodetector may allow longer integration times of an integrating capacitor connected to the photodetector as the electric charge accumulated by the capacitor may be reduced due to the dark current elimination. Elimination or cancellation of the dark current may be performed by subtracting a signal produced by a photodetector while being illuminated, from a signal produced by the same photodetector while not being illuminated. For elimination or cancellation of the dark current a net number of collected electric charges derived from the dark current becomes substantially zero. In some embodiments, the accumulated signal may also carry a statistical fluctuation known as “dark current noise” which may not be eliminated with elimination or cancellation of the dark current produced by a photodetector.

In some embodiments, the disclosed system may be configured to alternately allow or prevent illumination of a photodetector in order to generate a signal of the same photodetector under illumination and no-illumination conditions. In some embodiments, an optical shutter may be used to alternately allow or block illumination of a photodetector. The states of illumination and no illumination of the photodetector may be synchronized, e.g., by one or more electrical switches configured to switch between collection of a first type of electrical charge and a second type of electrical charge. For example, between hole and electron collection generated by the photodetector such that, when the photodetector is illuminated, a first type of electrical charge derived from combined photocurrent and dark current is collected by an integrating capacitor, and when the photodetector is not illuminated, a second type of electrical charge derived from dark current is collected by the integrating capacitor. Due to the opposite signs of the collected charges, the signal (charges) associated with dark current, e.g., collected when the photodetector is not illuminated, may cancel out the dark current collected when the photodetector is illuminated, leaving only the desired optical signal related charges collected when the photodetector is illuminated, e.g., the signal generated by photocurrent. In some embodiments, the first type of electrical charge is inverted by a switching system relative to the second type of electrical charge such that the inversion leads substantially to cancelation or elimination of collected electrical charges derived from the dark current. By eliminating, cancelling, or substantially reducing charges generated by dark current, a longer integration period may be possible, collecting primarily or only the desired optical signal related charges.

Advantageously, the disclosed system and method of use relies on physical cancellation of the collected charges and therefore may not require complex analogue circuitry or additional “dummy” photodetectors, thus further saving space in photodetector implementations. Further advantageously, the disclosed system and method of use may substantially reduce or eliminate dark current from a photodetector without reducing the detector responsivity. Use of the disclosed system and method may be particularly advantageous when the material used in the photodetector may be characterized by relatively high dark current, for example, when using Germanium-based photodiodes.

Henceforth in this description and for simplicity, the term “photodetector array” may be replaced with the acronym “PDA” and the term “photodetector” or “photodiode” may be replaced with the acronym “PD”. In some embodiments, A PDA may include multiple photosites each including one or more photodetectors, and the PDA and/or photosite may also include some circuitry or additional components in addition to the photodetector/s. A device configured to alternately allow or prevent illumination of a photodetector may be referred to herein for convenience as an “optical shutter” or “shutter”, but it should be appreciated that such a device is not limited to an optical shutter. The terms “optical signal” or “optical current” or “optical charge” or “photocurrent” may be used interchangeably herein to refer to a signal generated by a PD representative of a desired detected illumination. The terms “inverted”, “inverse” and “inversed” (referring to the electrical charges generated by the PD) may be used interchangeably herein.

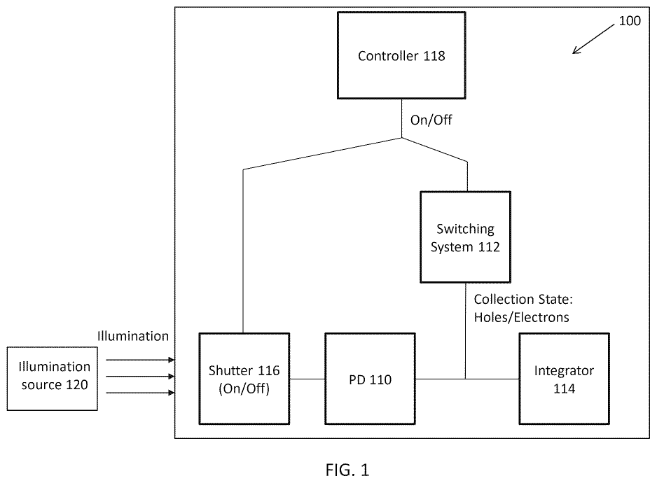

FIG. 1 is a schematic block diagram illustrating a system configured for dark current elimination, in accordance with some implementations of the presently disclosed subject matter. System 100 may include a photodetector 110, a switching system 112, an integrator 114, an optical shutter 116 and a controller 118.

PD 110 may detect incoming radiation or illumination such as reflected, ambient or direct illumination from an illumination source 120 to produce an electrical signal that is representative of the amount of impinging illumination within the detectable spectral range of PD 110. In some embodiments, illumination source 120 may be external to system 100 while in some embodiments, illumination source 120 may be integrated or may be part of system 100. In addition to the impinging illumination, the electrical signal produced by PD 110 may also include dark current, which may accumulate over the integration time and may be eliminated according to embodiments of this disclosure.

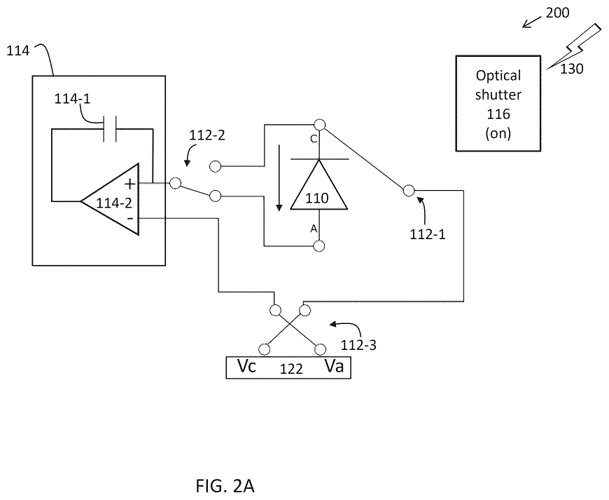

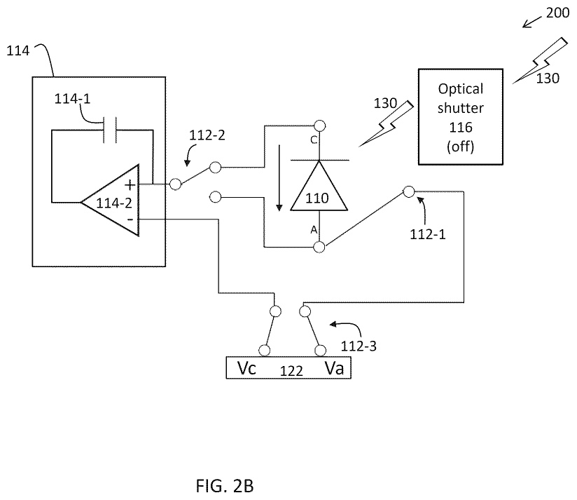

In some embodiments, PD 110 may include an anode and cathode that may be electrically connected to a voltage source, e.g., voltage source 122 of FIGS. 2A-2B, for applying a voltage across PD 110 for biasing PD 110 (such as a reverse bias for operation as a photodetector). PD 110 may generate free charge carriers, for example, a first type of electrical charge and a second type of electrical charge. In some embodiments, the first type of electrical charge is inversed to the second type of electrical charge, e.g., electrons and holes. For example, PD 110 may include a PN junction generating electrons and holes in a semiconductor. It should be understood by a person skilled in the art that any type of junction or an interface between two or more types of semiconductor materials which may generate electrons and holes may be used.

Switching system 112 may be used, activated, or controlled, e.g., by controller 118 to allow a desired operation of and synchronization of the components of system 100. According to some embodiments, switching system 112 may be connected to PD 110, to controller 118, to integrator 114 and to shutter 116. Any connection may be made such as to allow the desired operation of the component, for example, switching system 112 may be connected to PD 110 at an anode and at a cathode of PD 110.

In some embodiments, switching system 112 may include one or more electrical switches, e.g., voltage-controlled switches, current controlled switches, or any type of electrical switch. Switching system 112 may be connected to and controlled by controller 118. Switching system 112 may be configured to control switching between at least two states, also referred to herein as “collecting states” enabling collection of a signal generated by PD 110 by integrating capacitor 114. A collection state may be a period or a duration of time in which integrating capacitor 114 is charged or discharged. A collection state may be defined by a predetermined time in which the integrating capacitor 114 is charged or discharged while elements of system 100 are connected in a predetermined configuration.

Switching system 112 may control the configuration of system 100 as described in embodiments of the invention. For example, a first collection state may be synchronized with illumination reaching PD 110 and a second collection state may be synchronized with no illumination reaching PD 110 (or vice versa). In some embodiments, a first (illuminated) collection state may include collection of charge from PD 110 including charge derived from optical current and charge derived from dark current, and a second (non-illuminated) collection state may include collection of charge from PD 110 including charge derived from an inverse dark current.

Integrator or “integrating capacitor” 114 may be any capacitive device as known in the art to enable storing of electrical energy and to build a charge over an integration period that includes cumulative charges collected during the integration period. Integrator 114 may be connected to PD 110 via switching system 112 such that in each of the plurality of collection states, integrator 114 may be charged and/or discharged with charge generated by PD 110. For example, inverse charges (alternatively referred to herein as “inverse charge carriers”, “inverted charge carriers”, or “electrons and holes”) may alternately be collected in a first collection state and in a second collection state. According to the disclosed operation of system 100, alternating dark current related inverse charges may be collected by integrator 114, where the collected inverse dark current related charges may cancel one another out (or alternatively may be said to “charge and discharge” integrator 114) to thereby reduce, subtract, or eliminate charges derived from dark current during the integration period. In some embodiments, the integration period may be controlled by controller 118. In some embodiments, following the completion of an integration period, the accumulated signal collected in integrator 114 may be read by, or provided to an external device (not shown) for determining of the signal produced by PD 110 such that this signal may be used as part of, for example, an imaging system.

Optical shutter 116 may be configured to prevent or allow exposure of PD 110 to illumination. In this disclosure, optical shutter 116 may block illumination of PD 110 when optical shutter 116 is said to be “on” or “activated” and may allow illumination of PD 110 when optical shutter 116 is said to be “off” or “inactivated”. In some embodiments, optical shutter 116 may include, but is not limited to a mechanical optical shutter, a liquid crystal optical shutter, a MEMS optical shutter, and/or an active grating resonance coupling. In some embodiments, a single optical shutter 116 may be provided covering each PD 110 in a PDA for blocking/allowing illumination per PD 110, or alternatively a single optical shutter 116 may be provided covering multiple PDs 110 for simultaneously blocking or allowing illumination for covered multiple PDs 110.

Controller 118 may control operation and synchronization of the components of system 100. Controller 118 may be a computing device as described herein and may include a non-transitory computer readable medium containing instructions that when executed by at least one processor are configured to perform the functions and/or operations necessary to provide the functionality described herein. Where system 100 may be said herein to provide specific functionality or perform actions, it should be understood that the functionality or actions may be performed by controller 118 that may control other components of system 100. For example, controller 118 may activate optical shutter 116 to thereby prevent PD 110 from receiving any illumination, while simultaneously controlling switching system 112 to change the collection state of integrator 114 from a first collection state to a second collection states, e.g., from holes to electrons or vice versa.

In some embodiments, the functionality of controller 118 is provided by other components. In a non-limiting example, optical shutter 116 may include embedded switching logic that is connected to and activates switching system 112 (or vice versa).

For simplicity, FIG. 1 shows system 100 with a single PD 110, switching system 112, integrator 114 and optical shutter 116, but it should be appreciated that, in practice, system 100 may include any suitable numbers of PDs 110 formed into a PDA, with a corresponding number of switching systems 112, integrators 114 and optical shutters 116.

In use system 100 may function as follows: PD 110, connected to integrator 114, may generate a first type of electrical charge when exposed to illumination and a second type of electrical charge, that may be inverted relative to the first type, when illumination of PD 110 is prevented. For example, the first type of electrical charge may include electrons and the second type of electrical charge may include holes or vice versa.

Controller 118 may use, control, or operate switching system 112 to switch between a first collection state of integrator 114 and a second collection state of integrator 114. The first collection state may be synchronized with illumination reaching PD 110 and the second collection state may be synchronized with no illumination reaching PD 110 (or vice versa). The first collection state may be synchronized with generation (by PD 110) of the first type of electrical charge and the second collection state may be synchronized with generation (by PD 110) of a second type of electrical charge. During the first collection state, integrator 114 may be charged by the first type of electrical charge and during the second collection state, integrator 114 may be discharged by the second type of electrical charge that is inverse to the first type of electrical charge. The amount of electrical charge from the first type may result from photocurrent and dark current while the amount of electrical charge from the second type may result only from dark current (or vice versa). Due to the opposite or inverted charge of the first and second types of electrical charges, e.g., holes and electrons, the electrical charge resulted or derived from dark current may be eliminated and integrating capacitor 114 may be left only with electrical charge resulting from light impinging on PD 110 (with no electrical charges resulting from unwanted dark current). The amount of electrical charge resulting or derived from dark current in the first collection state is the inverted charge to substantially the same amount of electrical charge resulting or derived from dark current in the second collection state and therefore the electrical charge resulting or derived from dark current is cancelled, subtracted, or eliminated after every two consecutive collection states, e.g., a first and a second collection state.

According to some embodiments, during the first collection state, shutter 116 is “off” and therefore illumination may reach PD 110. PD 110 may generate a first type of electrical charge, e.g., electrons, derived or resulted from both photocurrent (due to the impinging light energy) and from dark current (due to thermal energy within PD structure). Therefore, during the first collection state, integrating capacitor 114 may be charged by the first type of electrical charge derived from photocurrent and by first type of electrical charge derived from dark current. During the second collection state, shutter 116 is “on” and therefore no illumination may reach PD 110, namely PD may be under dark conditions. Although no illumination is reaching PD 110, PD 110 may generate electrical charges derived or resulting only from dark current. PD 110 may generate a second type of electrical charge, e.g., holes, derived or resulting from dark current (due to thermal energy within PD structure). Therefore, during the second collection state, the integrating capacitor may be discharged by the second type of electrical charge derived from dark current thereby substantially eliminating electrical charges derived from dark current.

FIGS. 2A and 2B are illustrative electrical circuit diagrams of a system for dark current elimination, in accordance with some implementations of the presently disclosed subject matter. The circuit diagrams of FIGS. 2A-2B show illustrative and exemplary circuit implementations of the system 100 of FIG. 1. Further, the circuit diagrams of FIGS. 2A-2B are simplified and may exclude other circuit components that are not considered essential for an understanding of the concepts disclosed herein. It should be understood to a person skilled in the art that circuit diagrams of FIGS. 2A-2B are merely exemplary implementation of system 100 of FIG. 1 and that any other circuit or implementation, including the same or different components and elements may be used to execute or implement embodiments of the disclosed subject matter.

Circuit 200 may include an integrating capacitor 114, a voltage source 122, a PD 110, a switching system 112 and a shutter 116. Circuit 200 may be configured to enable switching between a first collection state of integrating capacitor 114 and a second collection state of integrating capacitor 114, wherein the first collection state is synchronized with illumination reaching PD 110 and the second collection state is synchronized with no illumination reaching PD 110. In some embodiments, some, or all of the components of circuit 200 may be controlled by a controller such as controller 118 described above. In some embodiments, such as shown in the illustrative circuit diagrams of FIGS. 2A-2B, switching system may include a first, a second and a third switches, the first switch between the PD and the integrating capacitor, the second switch between the PD and the third switch, and the third switch between a power supply, the PD, and the integrating capacitor.

In some embodiments, such as shown in the illustrative circuit diagrams of FIGS. 2A-2B, integrating capacitor 114 may include a capacitor 114-1 and also an operational amplifier (OP AMP) 114-2 in a reverse feedback configuration. PD 110 may include two terminals, an anode denoted “A”, and a cathode denoted “B”, which output electrical charges with opposite signs. Voltage source 122 may include a cathode voltage (Vc) and an anode voltage (Va) where Vc may be applied to cathode (C) of PD 110 and Va may be applied to anode (A) of PD 110. Vc is the voltage applied on the cathode and Va is the voltage applied on the anode. Voltages Va and Vc may be applied to PD 110 such as to allow PD 110 to operate. For reverse biasing of PD 110 for functioning as a PD, Vc may be positive, and Va may be negative.

In some embodiments, switching system 112 may be configured to direct electrical connectivity within parts of circuit 200 such as to allow switching between a first collection state and a second collection state. Switching system 112 may connect PD 110 and integrating capacitor 114, allowing collecting alternately the first and second charge types. As shown in FIGS. 2A-2B, switching system 112, e.g., switching system 112 of FIG. 1 may include switches 112-1, 112-2, and 112-3. It should be understood by one skilled in the art, that using three switches represents an exemplary design and any number of switches may be used to switch between the two or more configurations of the plurality of terminals of PD 110, terminals of integrating capacitor 114, and terminals of voltage source 122 as described in embodiments of this disclosure.

In some embodiments, circuit 200 may be configured, by switching system 112, for collecting charges of a first type or from a second type. For example, as shown in FIG. 2B a first type of electrical charges may be collected by integrating capacitor 114 when the cathode (C) is connected to the positive terminal of capacitor 114-2, and cathode voltage Vc, is connected to the negative terminal of capacitor 114-2. The anode (A) is connected to anode voltage Va.

As shown in FIG. 2A a second type of electrical charges may be collected by integrating capacitor 114 when the anode (A) is connected to the positive terminal of capacitor 114-2, and anode voltage Va, is connected to the negative terminal of capacitor 114-2. The cathode (C) is connected to Vc.

Switches 112-1, 112-2, and 112-3 may be configured for operation such that Vc is applied to C and Va is applied to A, in both of the first and second collection states to ensure reverse biasing PD 110 and enabling photocurrent and dark current flows from C to A.

As shown in FIG. 2A, switches 112-1, 112-2, and 112-3 may be configured and substantially synchronized with optical shutter 116 such that, in a first collection state e.g., when PD 110 is not illuminated due to optical shutter 116 being “on” (light 130 is not reaching PD 110), a first type of electrical charge from PD 110 including dark current related charges may be collected by integrating capacitor 114. As shown in FIG. 2B, switches 112-1, 112-2, and 112-3 may be configured and substantially synchronized with optical shutter 116 such that, in a second collection state e.g., when PD 110 is illuminated due to optical shutter 116 being “off” (light 130 is reaching PD 110) a second type of electrical charge from PD 110 including photocurrent and dark current related charges are collected by integrating capacitor 114.

As shown in FIGS. 2A and 2B the rearrangement of circuit 200 by switching of switches 112-1, 112-2, and 112-3 results in the first type of charge collected in the first collection state being the inverse of the second type of charge collected in the second collection state such that integrating capacitor 114 is charged by the first type of charge derived from dark current and discharged by the inverse second type of electrical charge derived from dark current, thereby substantially eliminating or cancelling electrical charges derived from dark current. As described in embodiments of the disclosure, with reference to FIG. 1, controller 118 may direct the substantially synchronized switching of switches 112-1, 112-2, and 112-3 and optical shutter 116. It should be appreciated that while, in some embodiments, a first collection state of switching system 112 may be substantially synchronized with illumination of PD 110 (optical shutter 116 is “off”), and a second collection state may be substantially synchronized with no illumination of PD 110 (optical shutter 116 is “on”) in other embodiments, a first collection state of switching system 112 may be substantially synchronized with no illumination of PD 110 (optical shutter 116 is “on”), and a second collection state may be substantially synchronized with illumination of PD 110 (optical shutter 116 is “off”).

Since electrical charges related to or derived from dark current may be present in both of the first and second types of collected charges, the inverse first and second types of charges related to dark current cancel each other out to thereby substantially reduce, eliminate, or cancel dark current charge collection in integrating capacitor 114. By contrast, photocurrent related charges, e.g., electrical charges that results from light impinging on PD 110, collected only in the second collection state, accumulate in integrating capacitor 114 for the duration of an integration period.

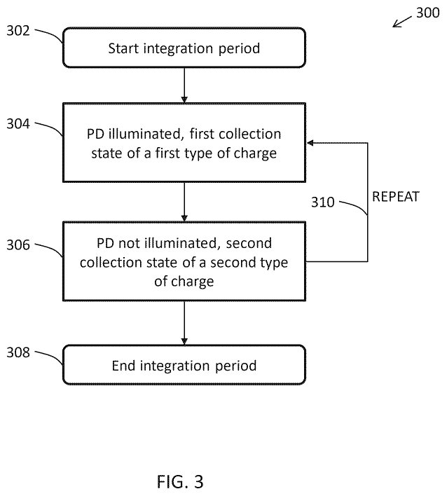

FIG. 3 is a flow chart of an example process for dark current elimination in an imaging system according to some implementation of the presently disclosed subject matter.

Flowchart 300 represents a process which may be performed, for example, by system 100 of FIG. 1, and/or circuits 200 of FIGS. 2A-2B. According to some embodiments of the disclosed subject matter, a non-transitory computer readable medium, associated with system 100, may contain instructions that when executed by at least one processor performs the operations described at each step as part of flowchart 300. The at least one processor may correspond, for example, to controller 118 of FIG. 1.

In step 302, an integration period for an integrating capacitor may start such as when integrating capacitor, e.g., integrating capacitor 114 has been discharged.

In step 304, illumination may reach a PD, for example, optical shutter 116 may be deactivated to allow or enable illumination of PD 110. PD 110 may generate a first type of charge that includes dark current related charges and photocurrent related charges. Substantially simultaneously, controller 118 and/or switching system 112 may switch integrating capacitor 114 to a first collection state in which integrating capacitor 114 may collect or be charged by charges of the first type (electrons or holes) generated by PD 110. In some embodiments of the disclosure, the optical shutter is controlled by the controller and allowing or blocking of illumination is substantially synchronized by the controller with the switch between the first collection state and the second collection state.

In step 306, illumination may be prevented from reaching the PD, for example, optical shutter 116 may be activated to prevent illumination of PD 110. PD 110 may generate a second type of charge that includes dark current related charges (and no photocurrent related charges as illumination is prevented). Substantially simultaneously, controller 118 and/or switching system 112 may switch integrating capacitor 114 to a second collection state in which integrating capacitor 114 may collect or be charged by charges of a second type of charge that are inverted relative to the first type (electrons or holes) generated by PD 110. Since PD 110 is not illuminated in step 306, no photocurrent related charge is generated by PD 110.

It should be appreciated that the inverse charges related to dark current collected during both of steps 304 and 306 may substantially cancel each other out to thereby eliminate the effect of dark current produced by PD 110. The dark current cancellation may be enabled by charging and discharging of the integrating capacitor by the same amount of electrical charges, due to the inverted charges derived from dark current in each of the collection states.

While the first collection state is synchronized with illumination reaching the PD and generation of the first type of electrical charge, the second collection state is synchronized with no illumination reaching the PD and generation of the second type of electrical charge. Thus, during a cycle of both of a first collection state and a second collection state the electrical charge derived from dark current collected by the integrating capacitor is cancelled and only electrical charge derived from photocurrent is collected in the integrating capacitor.

It should be appreciated that the process represented by flowchart 300 may alternately provide for a non-illuminated step (such as step 306) followed by an illuminated step (such as step 304) such that a first type of charge including only dark current related charges may be collected in a first collection state and a second type of charge including dark current related charges and photocurrent related charges may be collected in a second collection state.

Steps 304 and 306 may be repeated as indicated by arrow 310 until the end of the integration period at step 308, when the collected charge in integrating capacitor 114 may be read and integrating capacitor 114 may be discharged in order to start a successive integration period. For example, the discharging of integrating capacitor 114 may be performed by a readout integrated circuit (ROIC) which may use the collected charge indicative of the photocurrent for imaging purposes.

It should be appreciated that the process represented by flowchart 300 may be repeated for each successive integration period. It should be appreciated that the process represented by flowchart 300 may be duplicated for every PD 110 that forms part of a PDA.

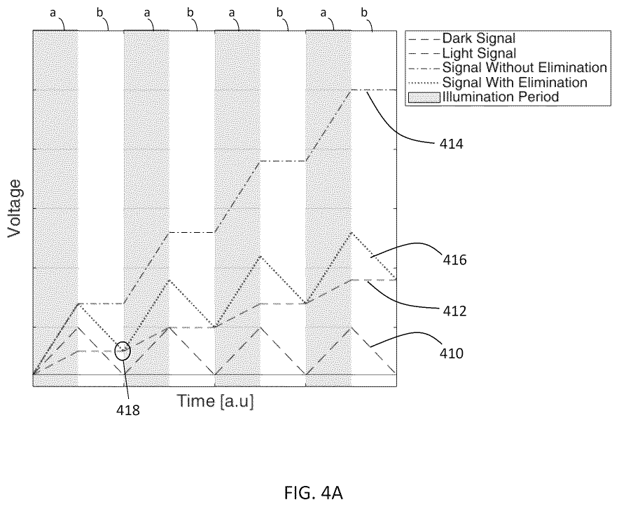

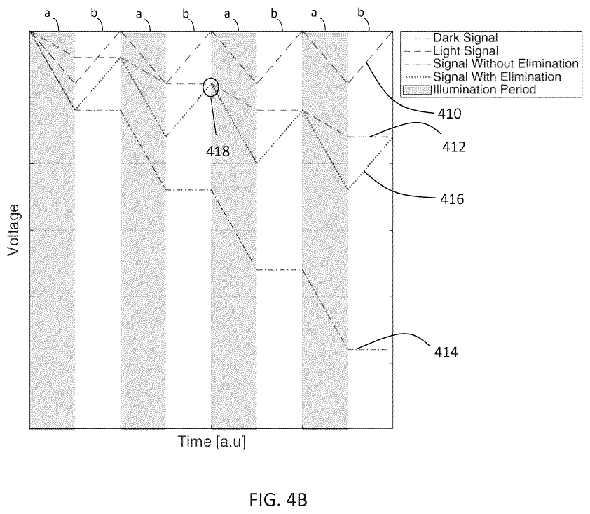

FIGS. 4A and 4B are exemplary graphs illustrating accumulated voltage across an integrating capacitor during a plurality of iterations of the process in flowchart 300 and/or 500, according to some implementations of the presently disclosed subject matter.

FIGS. 4A-4B show illuminated periods (denoted “a”) and non-illuminated periods (denoted “b”) of PD 110 such as may be generated by the on/off switching of optical shutter 116. According to embodiments of the disclosure, illuminated periods “a” and non-illuminated “b” may be synchronized with predefined collection states of the integrating capacitor, therefore illuminated periods “a” may be related to a first collection state while non-illuminated “b” may be related to a second collection state or vice versa.

Line 410 shows the accumulated dark current related voltage across integrating capacitor 114. As shown, as alternating inverse dark current related charges are collected by integrating capacitor 114, the dark current related charges may cancel one another out to substantially reduce or eliminate the effect of dark current on the collected charge. While during each of the illuminated periods “a” integrating capacitor is charged by a first type of electrical charge derived from dark current, during each of the non-illuminated periods “b” integrating capacitor is discharged by a same amount of an inverted second type of electrical charge derived from dark current as shown by line 410. Exemplary line 412 shows the incoming photocurrent related voltage signal representative of illumination detected by PD 110. As shown, during periods of no illumination of PD 110 (“b” periods), no photocurrent related charges are collected as no photocurrent is generated by PD 110.

In the absence of the system disclosed herein, as shown in the exemplary line 414, the dark current related charges may undesirably be added to the accumulated photocurrent related charges to thereby undesirably increase the collected charge in integrating capacitor 114 such that integrating capacitor 114 may reach its capacity prior to a completion of a desired integration time or such that the voltage read across integrating capacitor 114 may be unduly influenced by the collection of dark current related charges.

Exemplary line 416 shows the accumulated combined photocurrent related voltage and dark current related voltage across integrating capacitor 114 using system 100 as disclosed herein. As shown for example at point 418 (where lines 416 and 412 meet), following the completion of combined first and second collection states (one state having PD 110 illuminated and one state having PD 110 not illuminated), the voltage across integrating capacitor 114 is a result of photocurrent related charges only since dark current related charges have been cancelled out as shown by line 410.

It should be appreciated that, by reducing to substantially zero, cancelling or eliminating the effect of dark current, the charge collection may be lower or eliminated, and the integration time may therefore be increased relative to an integration time where dark current has an effect.

In FIG. 4A, system 100 is configured for collection of positive charges of photocurrent and in FIG. 4B for collection of negative charges of photocurrent. The alternative collection configuration may, as illustrated in FIGS. 2A and 2B, be activated depending on which collection state (FIG. 2A or 2B) is selected by controller 118 during illumination or non-illumination of PD 110. FIG. 2A shows a non-illuminated state and FIG. 2B an illuminated state, but it should be appreciated that these may be interchanged resulting in collection of positive charges of photocurrent or collection of negative charges of photocurrent.

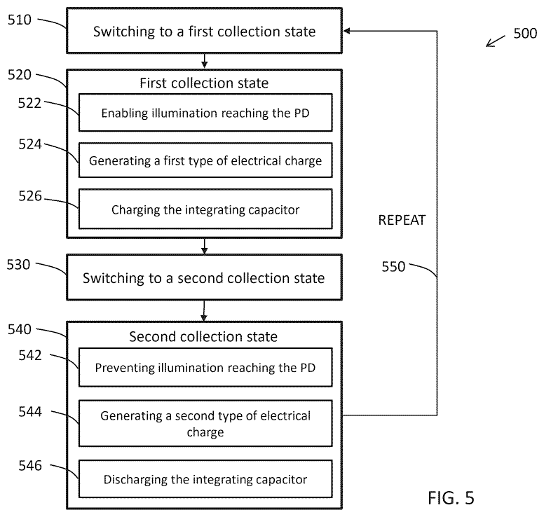

FIG. 5 is a flowchart of an example process for dark current elimination in an imaging system according to some implementation of the presently disclosed subject matter.

Flowchart 500 represents a process which may be performed, for example, by system 100 of FIG. 1, and/or circuits 200 of FIGS. 2A-2B. Therefore, steps or processes described by flowchart 500 may first include providing a photodetector (PD) connected to an integrating capacitor, and to a controller, such as presented in FIG. 1. The PD may generate a first type of electrical charge and a second type of electrical charge inverted relative to the second type of electrical charge. For example, positive charges and negative charges, e.g., holes and electrons.

As indicated by step 510, an integration period may start by switching, e.g., by a controller, to a first collection state of an integrating capacitor, e.g., integrating capacitor 114 of FIG. 1. It should be understood that an integration period for an integrating capacitor may start such as when integrating capacitor has been discharged.

Step 520 may indicate the first collection state which may include enabling illumination reaching the PD as indicated by step 522 and generating by the PD, a first type of electrical charge as indicated by step 524. In some embodiments of the disclosure, the first collection state may be synchronized with illumination reaching the PD and generation of a first type of electrical charge while a second collection state (indicated by step 540) may be synchronized with no illumination reaching the PD and generation of a second type of electrical charge, inverted relative to the first type. In some embodiments of the disclosure, the first collection state may be synchronized with no illumination reaching the PD while a second collection state (indicated by step 540) may be synchronized with illumination reaching the PD. For example, optical shutter 116 may be deactivated to allow or enable illumination of PD 110. During the first collection state, when illumination is reaching the PD, the PD may generate photocurrent related charges from a first type, e.g., holes or electrons and dark current related charges from a first type, e.g., holes or electrons. According to embodiments of the disclosure if the first type of electrical charge is holes, the second of electrical charge type may be electrons and vice versa.

Step 520 may further include charging the integrating capacitor, during the first collection state, by the first type of electrical charge derived from photocurrent and by a first type of electrical charge derived from dark current as indicated by step 526. For example, if the first type of electrical charge is holes, holes generated by photocurrent and holes generated by dark current may be collected by integrating capacitor which may be charged by a positive charge related to photocurrent and dark current.

In step 530, switching, e.g., by a controller, to a second collection state of an integrating capacitor, e.g., integrating capacitor 114 of FIG. 1 may be performed. Step 540 may indicate the second collection state which may include disabling or preventing illumination reaching the PD as indicated by step 542 and generating by the PD of a second type of electrical charge as indicated by step 544. During the second collection state, while illumination is prevented from reaching the PD, the PD may generate only dark current related charges and no photocurrent related charges. The generated charges, which are derived from dark current, may be of a second type of charge, inversed to the first type. For example, if the first type of electrical charge is holes, the second electrical charge type is electrons and vice versa. The controller may be configured in the first collection state and the second collection state to respectively route the first type of electrical charge and the second type of electrical charge to the integrating capacitor.

Step 540 may further include discharging the integrating capacitor, during the second collection state, by the second type of electrical charge derived from dark current, thereby substantially eliminating electrical charges derived from dark current as indicated by step 546.

For example, if the first type of electrical charge is holes, during the first collection state, holes generated by photocurrent and holes generated by dark current may be collected by the integrating capacitor which may be charged by a positive charge related to photocurrent and dark current. During the second collection state, a second charge type inversed to the first type, e.g., electrons generated by dark current may be collected by the integrating capacitor which may be charged by a negative charge related to dark current thereby discharging the integrating capacitor by the same amount of positive charge derived from dark current collected in the first collection state. The inversed charge of dark current related charges in the first and second collection states may cancel each other and therefore only electrical charge derived from photocurrent may be collected in the integrating capacitor while dark current related charges may be eliminated.

Steps 520 and 540 may be repeated as indicated by arrow 550 until an end of the integration period or until a predetermined time period is reached. The charge derived from dark current may be eliminated after every cycle of steps 520 and 540. When the collected charge in integrating capacitor 114 is read, e.g., by an ROIC, the collected charge which may be indicative of only the photocurrent may be used by the ROIC for imaging purposes.

It should be appreciated that the process represented by flowchart 500 may be repeated for each successive integration period. It should be appreciated that the process represented by flowchart 500 may be duplicated for every PD 110 that forms part of a PDA.

According to some embodiments of the disclosed subject matter, a non-transitory computer readable medium may contain instructions that when executed by at least one processor performs the operations described at each step as part of flowchart 500. The at least one processor may correspond, for example, to controller 118 of FIG. 1.

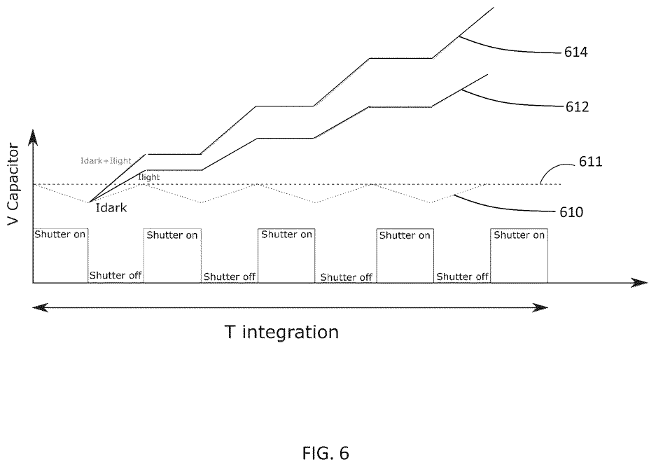

FIG. 6 is an exemplary graph illustrating accumulated voltage across an integrating capacitor during a plurality of iterations of the process in flowcharts 300 and/or 500, according to some implementations of the presently disclosed subject matter. FIG. 6 shows illuminated periods (denoted “shutter off”) and non-illuminated periods (denoted “shutter on”) of PD 110 such as may be generated by the on/off switching of optical shutter 116 and/or by controller 118. According to embodiments of the disclosure, illuminated periods and non-illuminated periods may be synchronized with predefined collection states of the integrating capacitor, therefore illuminated periods may be related to a first collection state while non-illuminated may be related to a second collection state or vice versa. The synchronization between the illuminated periods and non-illuminated periods and the collection state may be controlled by controller 118 via switching system 112 of FIG. 1.

Line 611 shows a reset value of the integrating capacitor represent a reference value of the integrating capacitor while it is discharged. Line 610 shows the accumulated dark current related charges across integrating capacitor 114. As shown, as alternating inverse dark current related charges are collected by integrating capacitor 114, the dark current related charges may cancel one another out to substantially reduce or eliminate the effect of dark current on the collected charge. While during each of the illuminated periods (“shutter off”) integrating capacitor is charged by a first type of electrical charge derived from dark current, e.g., electrons, during each of the non-illuminated periods (“shutter on”) integrating capacitor is discharged by a same amount of an inversed second type of electrical charge derived from dark current, e.g., holes, as shown by line 610. It should be understood to a person skilled in the art, that a line 610 of accumulated dark current related charges may be generated also under total dark conditions, namely when the shutter is in an “always on” position such that light is prevented from reaching PD 100. Line 610 may only be affected by charges resulted from dark current that may be generated when no photons are entering PD 110. In such embodiment, an alternative collection configuration, e.g., as illustrated in FIGS. 2A and 2B, may be activated by controller 118 without being synchronized to the state of shutter 116, e.g., shutter 116 may be always on.

Exemplary line 612 shows the incoming accumulated photocurrent related voltage charges representative of illumination detected by PD 110. As shown, during periods of no illumination of PD 110 (“shutter on” periods), no photocurrent related charges are collected as no photocurrent is generated by PD 110.

In the absence of the system disclosed herein, as shown in the exemplary line 614, the dark current related charges may undesirably be added to the accumulated photocurrent related charges to thereby undesirably increase the collected charge in integrating capacitor 114 such that integrating capacitor 114 may reach its capacity prior to a completion of a desired integration time or such that the voltage read across integrating capacitor 114 may be unduly influenced by the collection of dark current related charges.

It should be appreciated that, by reducing to substantially zero, cancelling or eliminating the effect of dark current as disclosed in embodiments of the disclosure, the collection of charge resulted from dark current may be eliminated, and the integration time may therefore be increased relative to an integration time where dark current has an effect on integrating capacitor 114.

Unless otherwise defined, all technical and scientific terms used herein have the same meaning as commonly understood by one of ordinary skill in the art to which this disclosure belongs. The materials, methods, and examples provided herein are illustrative only and not intended to be limiting.

Unless specifically stated otherwise, as apparent from the following discussions, it is appreciated that throughout the specification discussions utilizing terms such as “processing”, “calculating”, “computing”, “determining”, “generating”, “setting”, “configuring”, “selecting”, “defining”, or the like, include action and/or processes of a computer that manipulate and/or transform data into other data, said data represented as physical quantities, e.g. such as electronic quantities, and/or said data representing the physical objects.

The terms “computer”, “processor”, and “controller” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit, etc.), any other electronic computing device, and or any combination thereof.

The operations or some operations in accordance with the teachings herein may be performed by a computer specially constructed for the desired purposes or by a general-purpose computer specially configured for the desired purpose by a computer program stored in a computer readable storage medium.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure, or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter one or more stages or steps illustrated in the figures may be executed in a different order and/or one or more groups of stages may be executed simultaneously and vice versa. The figures illustrate a general schematic of the system architecture in accordance with an embodiment of the presently disclosed subject matter. Each module in the figures can be made up of any combination of software, hardware and/or firmware that performs the functions as defined and explained herein. The modules in the figures may be centralized in one location or dispersed over more than one location.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium or similar terms should be applied mutatis mutandis to a system capable of executing the instructions stored in the non-transitory computer readable medium and should be applied mutatis mutandis to method that may be executed by a computer that reads the instructions stored in the non-transitory computer readable medium.

Implementation of the method and system of the present disclosure involves performing or completing certain selected tasks or steps manually, automatically, or a combination thereof. Moreover, according to actual instrumentation and equipment of preferred embodiments of the method and system of the present disclosure, several selected steps could be implemented by hardware or by software on any operating system of any firmware or a combination thereof. For example, as hardware, selected steps of the disclosure could be implemented as a chip or a circuit. As software, selected steps of the disclosure could be implemented as a plurality of software instructions being executed by a computer using any suitable operating system. In any case, selected steps of the method and system of the disclosure could be described as being performed by a data processor, such as a computing platform for executing a plurality of instructions.

The connections as discussed herein may be any type of connection suitable to transfer signals from or to the respective nodes, units, or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Optionally, the illustrated examples may be implemented as circuitry located on a single integrated circuit or within a same device. Alternatively, the examples may be implemented as any number of separate integrated circuits or separate devices interconnected with each other in a suitable manner. Optionally, suitable parts of the methods may be implemented as soft or code representations of physical circuitry or of logical representations convertible into physical circuitry, such as in a hardware description language of any appropriate type.

Other modifications, variations and alternatives are also possible. The specifications and drawings are, accordingly, to be regarded in an illustrative rather than in a restrictive sense. While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure. It will be appreciated that the embodiments described above are cited by way of example, and various features thereof and combinations of these features can be varied and modified. While various embodiments have been shown and described, it will be understood that there is no intent to limit the disclosure by such disclosure, but rather, it is intended to cover all modifications and alternate constructions falling within the scope of the disclosure, as defined in the appended claims.

In the claims or specification of the present application, unless otherwise stated, adjectives such as “substantially” and “about” modifying a condition or relationship characteristic of a feature or features of an embodiment, are understood to mean that the condition or characteristic is defined to within tolerances that are acceptable for operation of the embodiment for an application for which it is intended. It should be understood that where the claims or specification refer to “a” or “an” element, such reference is not to be construed as there being only one of that element.

What is claimed is:

1. A system, comprising:
a photodetector (PD), wherein the PD generates a first type of electrical charge and a second type of electrical charge;
an integrating capacitor connected to the PD; and
a controller configured to switch between a first collection state of the integrating capacitor and a second collection state of the integrating capacitor,
wherein, during the first collection state, the integrating capacitor is charged by the first type of electrical charge derived from photocurrent and by the first type of electrical charge derived from dark current, and
wherein, during the second collection state, the integrating capacitor is discharged by the second type of electrical charge derived from dark current, wherein the first type of electrical charge is inversed to the second type of electrical charge such that electrical charges derived from dark current are thereby substantially eliminated.

2. The system of claim 1, wherein the first collection state is synchronized with illumination reaching the PD and wherein the second collection state is synchronized with no illumination reaching the PD.

3. The system of claim 2, wherein the first collection state is synchronized with generation of the first type of electrical charge and wherein the second collection state is synchronized with generation of the second type of electrical charge.

4. The system of claim 1, wherein the first type of electrical charge and the second type of electrical charge are respectively holes and electrons or vice versa.

5. The system of claim 1, wherein the controller is configured to alternatively route, during the first collection state, the first type of electrical charge to the integrating capacitor and during the second collection state, the second type of electrical charge to the integrating capacitor.

6. The system of claim 1, further comprising an optical shutter configured to allow or block illumination reaching the PD.

7. The system of claim 6, wherein the optical shutter is controlled by the controller and is configured to allow or block illumination reaching the PD in synchronization with switching between the first collection state and the second collection state.

8. The system of claim 6, wherein the optical shutter is one of a mechanical optical shutter, a liquid crystal optical shutter, a MEMS optical shutter, or an active grating resonance coupling.

9. The system of claim 1, further including a switching system connecting the PD and the integrating capacitor, wherein the switching system is configured to switch between the first collection state and the second collection state.

10. The system of claim 9, wherein the switching system includes a first, a second and a third switches, the first switch between the PD and the integrating capacitor, the second switch between the PD and the third switch, and the third switch between a power supply, the PD, and the integrating capacitor.

11. A method, comprising:
providing a photodetector (PD) connected to an integrating capacitor, and to a controller, wherein the PD generates a first type of electrical charge and a second type of electrical charge inversed to the second type of electrical charge;
switching, by the controller, to a first collection state of the integrating capacitor;
charging the integrating capacitor, during the first collection state, by a first type of electrical charge derived from photocurrent and by a first type of electrical charge derived from dark current;
switching, by the controller, to a second collection state of the integrating capacitor; and
discharging the integrating capacitor, during the second collection state, by the second type of electrical charge derived from dark current, thereby substantially eliminating electrical charges derived from dark current.

12. The method of claim 11, wherein the first collection state is synchronized with illumination reaching the PD and wherein the second collection state is synchronized with no illumination reaching the PD.

13. The method of claim 11, wherein the first collection state is synchronized with generation of the first type of electrical charge and wherein the second collection state is synchronized with generation of the second type of electrical charge.

14. The method of claim 11, wherein the first type of electrical charge and the second type of electrical charge are respectively holes and electrons or vice versa.

15. The method of claim 11, wherein the controller is configured in the first collection state and the second collection state to respectively route the first type of electrical charge and the second type of electrical charge to the integrating capacitor.

16. The method of claim 11, further including, providing an optical shutter configured to allow or block illumination of the PD.

17. The method of claim 16, wherein the optical shutter is controlled by the controller and wherein the allowing or blocking of illumination is substantially synchronized by the controller with the switch between the first collection state and the second collection state.

18. The method of claim 16, wherein the optical shutter is one of a mechanical optical shutter, a liquid crystal optical shutter, a MEMS optical shutter, or an active grating resonance coupling.

19. The method of claim 11, further including providing a switching system connecting the PD and the integrating capacitor, wherein the switching system is configured to switch between the first collection state and the second collection state.

20. The method of claim 19, wherein the switching system includes first, second and third switches, the first switch between the PD and the integrating capacitor, the second switch between the PD and the third switch, and the third switch between a power supply, the PD, and the integrating capacitor.
